(19) United States
(12) Patent Application Publication
(10) Pub. No.: US 2023/0394528 A1
(43) Pub. Date: Dec. 7, 2023

(54) A MOBILE APPLICATION SYSTEM THAT PROVIDES TO MEET THE NEEDS WITH WRITTEN OR AUDIO INFORMATION ACCORDING TO THE USER CLASSIFIED AND DEFINED REQUESTS

(71) Applicant: Emine AKBAY, Ankara (TR)

(72) Inventor: Emine AKBAY, Ankara (TR)

(21) Appl. No.: 18/033,803

(22) PCT Filed: Oct. 26, 2020
(86) PCT No.: PCT/TR2020/050994

§ 371 Date: Apr. 26, 2023

(30) Foreign Application Priority Data
Oct. 26, 2020 (TR) 2020/17011

(51) Int. Cl. G06Q 30/0251; G06Q 30/0241

(52) U.S. Cl. CPC G06Q 30/0257; G06Q 30/0267; G06Q 30/0248

(57) ABSTRACT

Invention, the user, the buyer or the customer, by downloading them to their smart devices such as computers, phones, tablets, can make written or audio requests for the services or products that are specially categorized and interested and needed, and the user requests that only the relevant and desired sellers can see these requests through the interface. It is about a mobile application system that provides information and meeting needs. User buyers or customers can define their demands in a target-oriented manner through the advertisement platform created with the inventive system and announce them in written or voice, record the announced products or services so that they can be seen by all kinds of sellers who produce and supply, and the sellers can respond to the requests in line with the target-oriented and customer trends. If the user wishes, they can use the options such as price, brand, location, etc. during the announcement stage to save time to search for the product or service they want to buy, and reach that product or service with the best quality and price performance.

### TECHNICAL FIELD

Invention, the user, the buyer or the customer, by downloading them to their smart devices such as computers, phones, tablets, can make written or audio requests for the services or products that are specially categorized and interested and needed, and the user requests that only the relevant and desired sellers can see these requests through the interface. It is about a mobile application system that provides information and meeting needs.

User buyers or customers can define their demands in a target-oriented manner through the advertisement platform created with the inventive system and announce them in written or voice, record the announced products or services so that they can be seen by all kinds of sellers who produce and supply, and the sellers can respond to the requests in line with the target-oriented and customer trends. If the user wishes, they can use the options such as price, brand, location, etc. during the announcement stage to save time to search for the product or service they want to buy, and reach that product or service with the best quality and price performance.

### PRIOR ART

For today's people, who spend most of their time with a computer or smart phone, it is possible to say a new need to meet a basic need such as shopping through online sites. With the development of technology, online shopping, which is one of the advantages offered by the internet, has become popular and highly preferred today. In this way, people can order the product they want without leaving home. In the mentioned shopping systems, sellers display their goods and services and buyers can reach their demands by making a call through the sales platform.

In the most general view of an online shopping transaction, there are two parties, sellers and buyers. In all of today's shopping practices, the needy, in other words the customers, so that they can buy the product or service they want;
To participate in the physical or internet environment,
Choosing according to quality or brand,
Determining the physical condition of the product or service (color, size, etc.)
Choosing a geographic location when necessary,
Price browsing or comparison,
To examine the conditions of access to the product or service,
In case of need, size, size etc. determinations
There is a lengthy process of gathering together many search details such as payment options reviews, and then reviewing your favorite picks, resulting in final decision making and purchasing.

In the current online market practices, products or services are offered, presented or promoted. Buyers choose using a wide variety of individual criteria, and Buyers track the products or services of vendors or suppliers.

In the Turkish Patent document numbered TR 2010/06302 related to the subject in the art, a mobile commerce method created dynamically using mobile phones or mobile devices based on the user position is mentioned. In the method, commercial opportunities are offered based on the geographical location information of the users who are members. In the aforementioned system, sellers only provide geographic target-oriented information transmission about their products and services.

As mentioned above, instead of seeing the products or services that the buyer or customer needs through a network-based system in the systems in the technique, defining what they want personally and providing the sellers or suppliers to reach them through written or voice announcements and using filters and searching for the required product or service. instead, it is not mentioned that the buyer or customers will categorize the products or services from the very beginning and define and announce them in writing or voice, so that they do not need to use filters.

### DESCRIPTION

The subject of the invention is a mobile application system that provides information and fulfillment of the demands of the user, buyer or customer comprising;
A user interface module where the user buyer or customer categorizes the products or services requested by himself, makes written or audio notifications by marking, and informs the user buyer or customers in written or audible terms by the sellers in audio, visual and written form
A vendor interface module that allows sellers to monitor and track products or services that are categorized specifically for users, buyers or customers, and classify the products or services in question and convey target-oriented information to users.
A management interface module that checks the conformity of the products or services requested by the user buyers or customers to the law and morality, controls the transmission of information and data through the seller interface module, providing the communication between the parties and displaying various information and advertisements.
A vendor or supplier target interface module that allows users, buyers or customers to categorize the products or services they request in written or audio form, only to the sellers specified by the user and to communicate with the buyer or customer and present their products and services to the user.

In a mobile application system that provides written or audio information according to the requests of the user, in other words the buyer or customer, the subject of the invention, the buyer will be the focus by defining the product or service he needs, and on an application platform where he will define the product or service he requests correctly and in accordance with his category, It is sufficient to define the product and service it wants to buy according to its own criteria and to announce it in writing or voice.

In a mobile application system that provides information according to the demands of the user, buyer or customer, the subject of the invention, those who are in the position of a seller (manufacturer or supplier) can follow the products and services requested by the buyers. Sellers search for “Who or who wants what product or service?” Therefore, the target and target audience of the sellers is to examine the customers and the products or services categorized, defined, written or audibly announced or published by them and to make an offer regarding the product or service that they or their institution can provide. In the event of these offers, the data are categorized and classified and taken into an interface to be delivered to the buyers.

In a mobile application system that provides information according to the needs of the user, buyer or customer, the subject of the invention, especially those who respond to the product or service request, namely the sellers, all kinds of audio, visual and written information such as photographs, videos, location, references or will be able to share the data with the requester.

In the system of the invention, buyers will no longer spend a long time on the screen for the product or service they need and will not examine the sites of the sellers. On the contrary, sellers will examine the product or service advertisements needed by buyers, namely customers, and will be able to reach them.

The subject of the invention, in a mobile application system that provides information and meeting the needs according to the customer or customer demands, the buyer wishes to organize a birthday. Primarily, the buyer sets a budget and defines what he wants for his birthday, such as food, drink, music, location, number of participants, etc. As soon as the need for this service is announced through the system, the persons or institutions that make such organizations will forward their offers to the customer or the buyer, the appropriate organization will be selected by the person requesting the service and the shopping will be completed.

To give another example, the buyer wants to buy a computer bag. When the brand categorizes the products in terms of color, type, price, all bag manufacturers or sellers or second hand owners can offer an offer at the announced price or lower if they have products suitable for demand.

In this way, the buyer is prevented from wasting time, as well as seeing the best price-quality offers and making efficient shopping.

To give another example;

The buyer or customer wants to buy a refrigerator. The size, color, capacity of the refrigerator, deep freezer or only cooler, price and payment options etc. During the course of defining such features and completing the advertisement, FOR EXAMPLE, this advertisement may only request A or B brand refrigerator manufacturers or suppliers.

If the brand is not important, the required refrigerator demand can reach all white goods vendors.

The important thing is to ensure that each time a new product or service request announcement is created by the buyer or customer, the request subject to the advertisement is instantly available to the screen of the relevant seller or supplier. This will provide the customer or buyer with the opportunity to both save time and reach the most economical and the highest performance product or service that reaches them quickly.

As mentioned in the examples above, the user selects all kinds of products and service groups through the customer or customer interface module in a way that is categorized specifically for their needs and demands target-oriented. Sellers, on the other hand, will present their options to the buyers or customers through the seller interface module based on the demands of the users.

In a mobile application system that provides information according to the needs of the user, buyer or customer, the subject of the invention, land, land, all kinds of houses, all kinds of workplaces (factory, school, office, clinic, fuel station, warehouse, etc.) It is also possible to purchase and rent various antique products. It also includes leasing or purchasing services for all real estate and movables. The application platform of the invention includes all kinds of products and services, including movable immovables that may be subject to need.

1. (canceled)

2. A mobile application system of the present invention that provides written or audio information to meet the needs of the customer according to the product or service demands that are classified and defined by the customer comprising of
A user interface module that allows the customer to categorize the product and service that they want to buy or rent, to define them with written or voice notification on a smart device, smartphone or a computer, and to create an advertisement and transfer it to the database,
A vendor interface module which functions with a special software that allows customers to monitor the advertisements that they have requested in a specially categorized form, via a smart device, smartphone or a computer, and enable them to bid for the advertisement defined by written or voice notification,
A management interface module that functions with a special software that controls the legality and morality of the advertisements defined by the customers, directs the messages between the seller and the customer, and enables the display of various information and advertisements, and manages the database,
and characterized in that the present invention comprises
A supplier target processor that functions with special software that provides access to the information of the vendors who supply the advertisement in the database defined by the customer to the system only as defined by the customer, and to the communication between the user interface panel and the vendor interface panel.
